(19) United States
(12) Patent Application Publication
(10) Pub. No.: US 2005/0192714 A1
(43) Pub. Date: Sep. 1, 2005

(54) Travel assistant device

(76) Inventors: Walton Fong, San Jose, CA (US); Donald Gillis, San Jose, CA (US); Andrei Khurshudov, San Jose, CA (US); Remmelt Pit, Cupertino, CA (US)

Correspondence Address: INTELLECTUAL PROPERTY LAW OFFICE, 1901 S. BASCOM AVENUE, SUITE 660, CAMPBELL, CA, 95008, US

(21) Appl. No.: 10/789,666

(22) Filed: Feb. 27, 2004

(51) Int. Cl. G01C 21/30

(52) U.S. Cl. 701/1

(57) ABSTRACT

A travel assistant device includes a hard disk drive including at least one database, a digital camera, a microphone, a display screen, and at least one speaker. The hard disk drive is provided with database software by which images and sound input from the digital camera and the microphone are stored in the hard disk drive as a personal log database. Images and sound files can be displayed on the display screen and through the speaker, and the personal log database may be updated by additional commentary and images as desired. The database software also retrieves downloaded database information which includes images, sound files and text which act as a travel instructor. Also preferably included is a portable translator device.

### BACKGROUND OF THE INVENTION

1. Field of the Invention

The present invention relates generally to personal devices for recording personal experiences and providing personal instruction including translations of foreign languages.

2. Description of the Prior Art

Travelers have always needed the guidance of some local authority in order to find their ways through foreign lands. There are traditionally native guides that can help travelers find food and lodging as well as pointing out local attractions and points of interest. As with any other field of human endeavor, certain of these guides may have been found to be motivated by interests other than those which were best for the client, as when some may serve to deflect tourists to establishments which hire the guides for this purpose. It is also impossible for every guide to be uniformly well-informed and reliable. As it is sometimes difficult to determine which of these guides may be trustworthy, some travelers resort to packaged tours with escorts that shepherd groups of tourists about. Other travelers may rely on tour books, which have the advantage of being at least generally knowledgeable on a wide variety of subjects of local interest. However, they are naturally mass produced, and therefore not tailored to any one individual, and certainly they are not interactive with the user, as a human guide would be.

Travelers have also become more and more fond of documenting their journeys, and tend to carry increasing numbers of still and video cameras, journals and log books with them.

Travelers also often need the assistance of translators which can interpret the number of signs, menu listings, and printed materials they will encounter in their travels. Although there are computer programs that can be used to recognize optical characters, and even translate materials from one language to another, these currently require equipment such as a flat-bed scanner, and a personal computer or at least a laptop computer to be effective, and are not well suited for a traveler, who may be having trouble just handling his or her luggage.

Thus, there is a need for a travel assistant device which combines many of these features in a compact unit, which can aid in translating printed material without bulky or complicated equipment, which can be used to document a traveler's journeys and which can provide detailed instruction and commentary to aid the traveler on his way.

### SUMMARY OF THE INVENTION

A preferred embodiment of the present invention is a travel assistant device, which includes a hard disk drive including at least one database, a digital camera, a microphone, a display screen, and at least one speaker. The hard disk drive is provided with database software by which images and sound input from the digital camera and the microphone are stored in the hard disk drive as a personal log database. Images and sound files can be displayed on the display screen and through the speaker, and the personal log database may be updated by additional commentary and images as desired. The database software also retrieves downloaded database information which includes images, sound files and text which act as a travel instructor. Also preferably included is a portable translator module.

The portable translator module uses the hard disk drive with a translation database. The digital camera inputs graphic images of words in a language unfamiliar to the user, and an Optical Character Recognition engine which resides on said hard disk drive, takes input graphic images of words in a language unfamiliar to the user and converts them to characters in the unfamiliar language. A dictionary module then takes the characters generated by the Optical Character Recognition engine and produces translated files in a language familiar to the user, and outputs them to the user through the screen and speaker.

It is an advantage of the present invention that it combines a number of devices in one package, so that there are fewer separate devices to handle while traveling.

It is another advantage of the present invention that a Hard Disk Drive device can carry significantly more information than a paper tour guide, and thus also minimizes the numbers of items that a traveler must carry.

It is a further advantage of the present invention that by including a Global Positioning System, the user is allowed to get interactive information from digital guides, and may allow the user to be tracked or located if he becomes lost.

It is still another advantage of the present invention that it can provide translations of signs and printed matter by use of an internal dictionary and OCR functions, and new dictionaries or travel guides can be downloaded to match the location and circumstances of the traveler.

It is yet another advantage of the present invention that it can act as a personal log to record events of a user's travels in a digital form which can be uploaded to external memory devices or websites.

It is an advantage of the present invention that it can provide personalized directions and commentary for the instructions of the traveler, and can record additional commentary for the traveler.

These and other features and advantages of the present invention will no doubt become apparent to those skilled in the art upon reading the following detailed description which makes reference to the several figures of the drawing.

### IN THE DRAWINGS

The following drawings are not made to scale as an actual device, and are provided for illustration of the invention described herein.

FIG. 1 is a diagram of the travel assistant of the present invention used as a translator;

FIG. 2 is a block diagram of the functional blocks of the travel assistant;

FIG. 3 is a block diagram of the functional blocks of the travel assistant showing input, storage and output functional blocks;

FIG. 4 is a diagram of the functional blocks of the travel assistant when used in the translator function mode;

FIG. 5 is a block diagram of the travel assistant when used in the travel instructor function mode;

FIG. 6 is a diagram of the functional blocks of the travel assistant when used in the travel instructor function mode;

FIG. 7 is a block diagram of the travel assistant when used in the travel log function mode;

FIG. 8 is a block diagram of the travel assistant when used in the personal log function mode; and

FIG. 9 is a diagram of the functional blocks of the travel assistant when used in the travel log function mode.

### DETAILED DESCRIPTION OF THE PREFERRED EMBODIMENTS

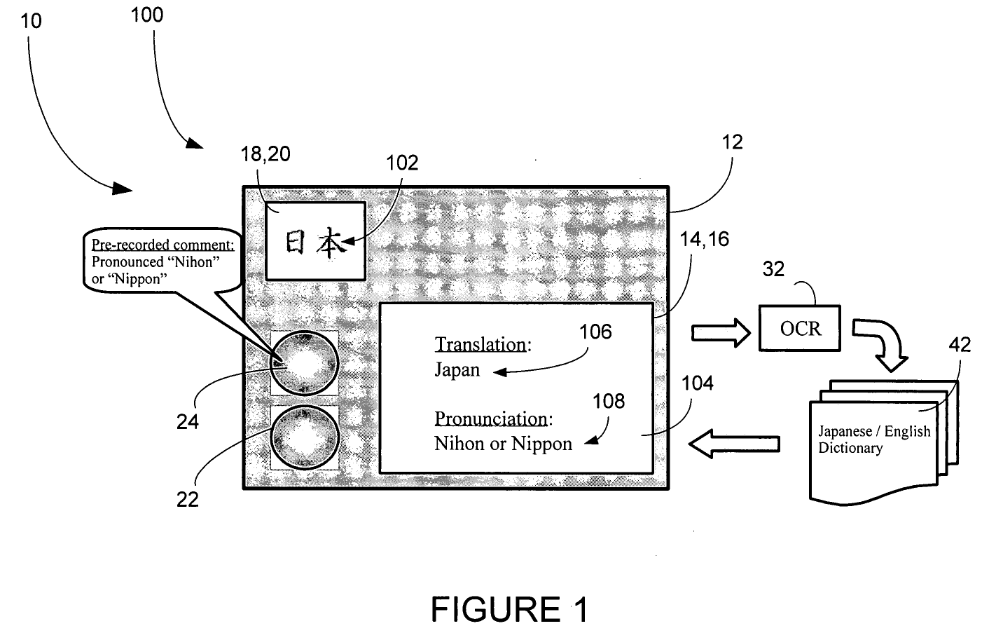

A preferred embodiment of the present invention is a digital travel assistant. As illustrated in the various drawings herein, and particularly in the view of FIG. 1, a form of this preferred embodiment of the inventive device is depicted by the general reference character 10.

Travelers to foreign lands have always needed the guidance of some local authority in order to find their ways. FIG. 1 shows a travel assistant 10 to store, reproduce and process personal data on demand during a trip. Generally, the travel assistant 10 includes a casing 12 into which is built a display or screen 14, which is preferably an LCD display 16. The travel assistant 10 also includes a digital camera 18 having a viewfinder 20, and a microphone 22 and a speaker 24.

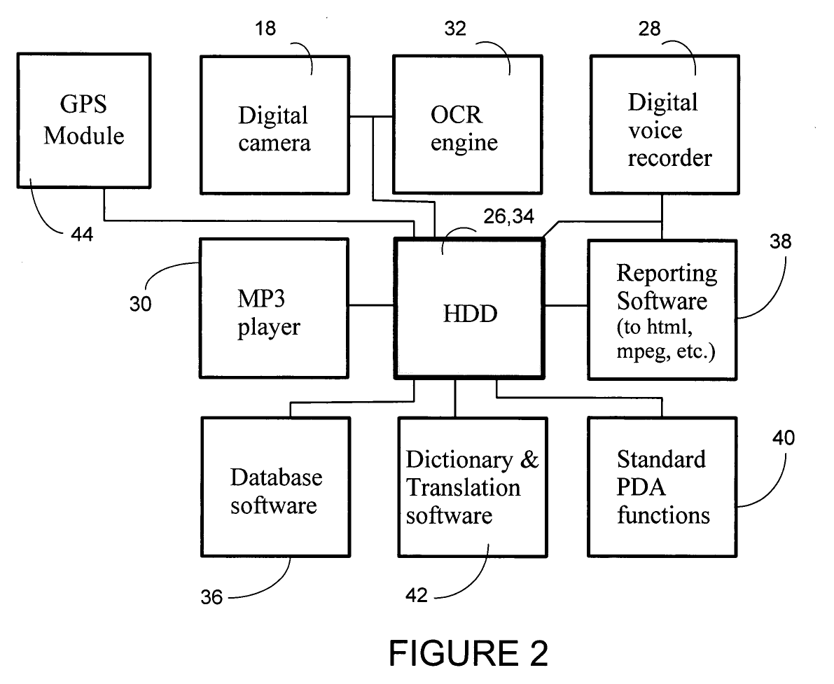

FIG. 2 shows a block diagram of the internal functional blocks included within the travel assistant 10. Central to all the functions is a Hard Disk Drive (HDD) 26. It is to be understood that although an HDD is preferred, other direct access storage devices such as solid-state storage, MEMS storage, optical storage, magneto-optical storage, etc. could be used. A digital camera 18, digital voice recorder 28, and MP3 player 30 are included as well as an Optical Character Recognition (OCR) engine 32. A data base 34 is included in the HDD 26 which includes database software 36. Also resident on the HDD 26 are software applications for reporting 38, which includes graphic image handling and formatting software, software for handling standard PDA functions 40 and dictionary and translation software 42, which can be downloadable and thus customized to the country and location the traveler finds himself in. A Global Positioning System (GPS) module 44 is also preferably included. This GPS module 44 can be useful as it can be used to allow the user to get interactive information from digital guides, and may allow the user to be tracked or located if he becomes lost.

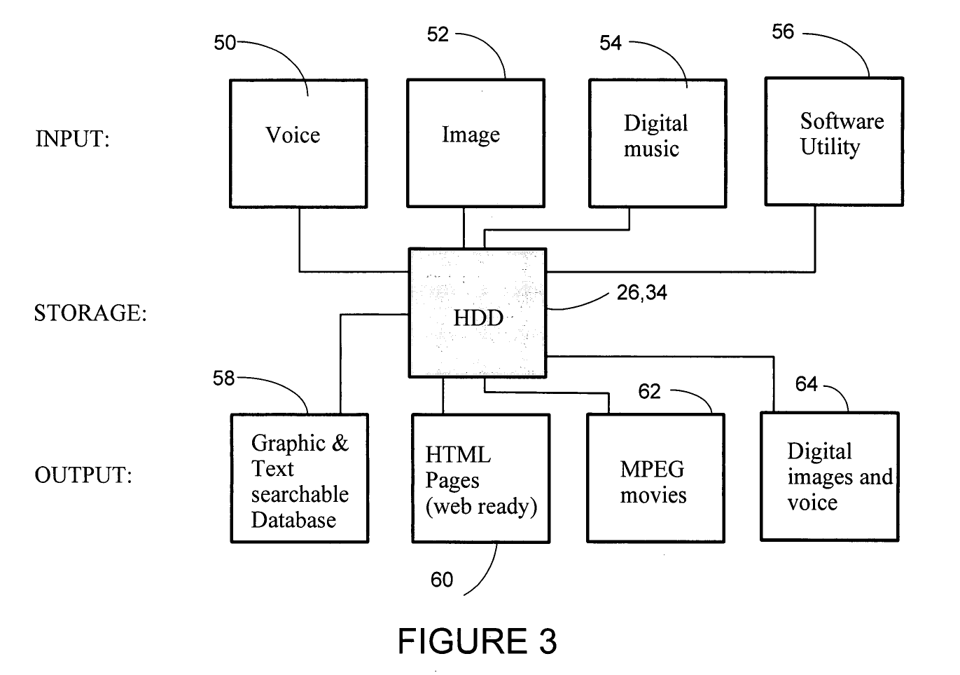

FIG. 3, with reference also to FIG. 1, shows a block diagram of various input and output types and formats which are input to the HDD 26 and its internal database 34. As input, voice 50 or sound can be input through the microphone 22. Images 52 can be input through the digital camera 18. Digital music 54 can be input through a number of input ports (not shown) which include all the conventional input sources such as by cable or wireless communication, or through a CD drive or player (also not shown). Software utilities 56 can also be downloaded through an access port or through a CD drive. Once data has been input, it can be manipulated through any number of software utilities, so that the files can be formatted or converted to other compatible formats for storage or output.

Output files and formats can include various types of graphic and text files 58, which are retrieved from a searchable database 34. HTML pages 60 can also be sent to the internet after an internal software utility (not shown) stored in the HDD 26, such as an HTML editor, has been used to format and mount the graphic image 52 and sound files received by the travel assistant 10. These could be presented as updates to a personal web site displaying “How I Spent My Summer Vacation”, etc.

Also available for output are MPEG movie files 62, digital image and sound files 64 of various formats including voice data, and it is also possible that these files be included in the web pages 60 or that the web pages contain links to locations on a server after they have been uploaded from the travel assistant 10.

The output is done through several methods. The sound files such as voice 64 and digital music 56 can be output through the built-in speaker 24 and digital images 64 and MPEG movies 62 can be shown on the screen 14 which is preferably an LCD display 16. These files can also be output through conventional, ports such as USB ports, etc. or modems, of either cable or wireless type.

With continuing reference to FIGS. 1-3, an example is given of the function of the travel assistant 10 as a portable translation device 100. It is assumed that the user is an English speaker traveling to Japan, and the user has downloaded software specific to this country, which could be obtained from a provider such as “Lonely Planet” or “Frommers”, and which includes a Japanese/English Dictionary as an example of dictionary software 42, discussed above. In this function, the digital camera 18 is used to photograph a sign containing Japanese characters 102. These are input as digital images 52 and stored either on the hard drive 26, or in a temporary memory storage as a graphic image file, in one of several formats, i.e. JPEG, TIFF, etc. In response to a prompt from the travel assistant 10, the user may designate whether the graphic file is to be stored in the database 34, or whether it is to be operated upon by one or more of the software applications 56 which have been loaded in the HDD 26. A choice is then input by the user by an input device, such as a touch screen button or buttons (not shown). In this example, in response to a query presented by the travel assistant's software, the graphic image 52 is sent to an OCR engine 32, which matches the graphic image 52 to a character 102, and a slide 104 matching the character 102 is shown on the screen 14. The slide 104 preferably displays the translation 106, and a pronunciation 108. In addition, a sound file 64 corresponding to the sound of the spoken character is optionally retrieved and played through the speaker 24. The sound file 64 which is played may include commentary on various items of interest or concern such as inflection, proper usage depending on social situation, or regional variance, etc.

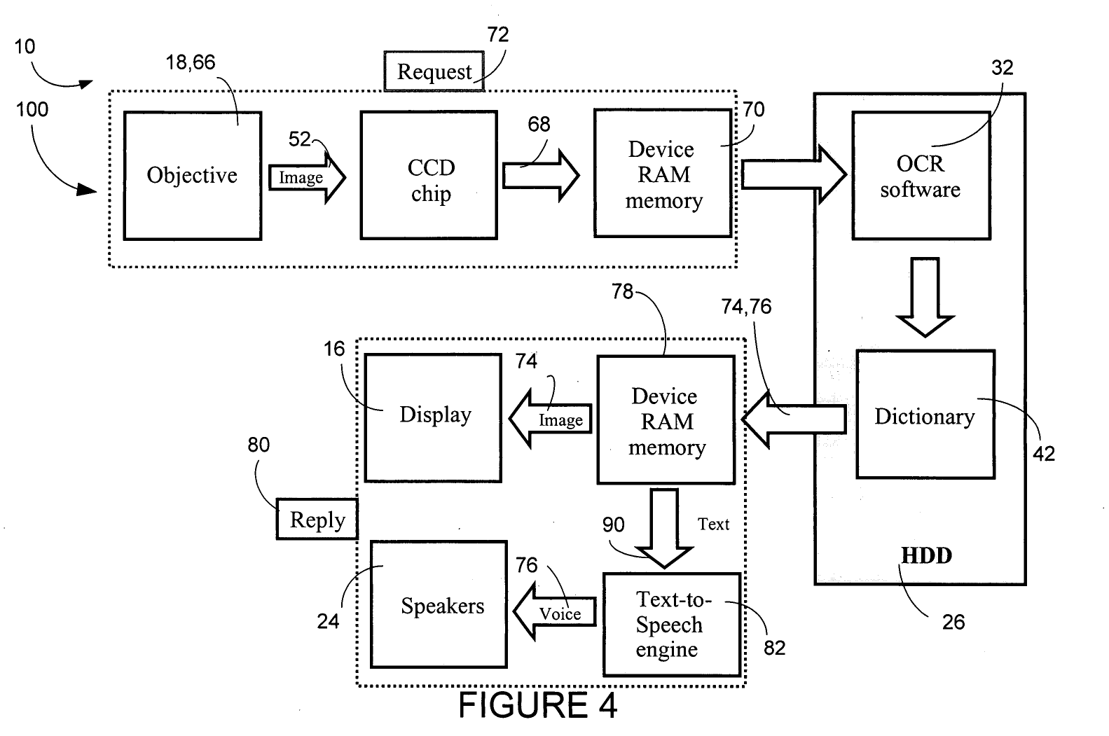

FIG. 4 shows a block diagram of the elements of the travel assistant 10 in use as a translation device 100. An image 52 enters the objective lens 66 of the digital camera 18, and activates a Charge Coupled Device (CCD chip) 68 before the image data is stored in a device RAM memory 70. This sequence of events can be referred to collectively as initiating a request 72 for translation. It is possible that a touch screen button (not shown) has previously be activated to initiate this series of events and to identify that the image is to be used for translation purposes rather than for adding to the personal log function, or some other identifier has been used, as is known in the art.

The image data 52 held in Ram 70 is then introduced to the OCR software 32 and compared to internal dictionary software 42, which produces a match with the characters in the image 52, and retrieves corresponding translated image 74 and voice files 76, which are delivered to a second device RAM memory 78. The translated image files 74 are delivered to the display screen 16, and text is processed by a text-to-speech engine 82, which produces a translated sound file 76 which is then delivered to the speakers 24.

Thus, the characters 102 produce a request 72 to be translated which produces a reply 80, which includes image files 74 such as a slide 104, which could contain English word translations 106, with phonetic pronunciation information 108, or could produce pictures. The speaker 24 can then play back the sound files 76.

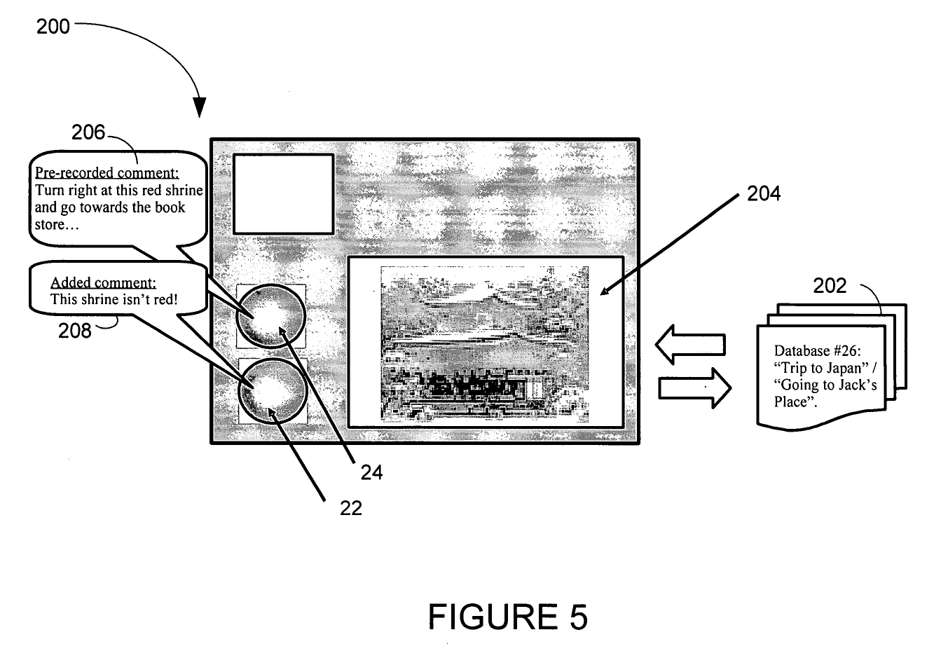

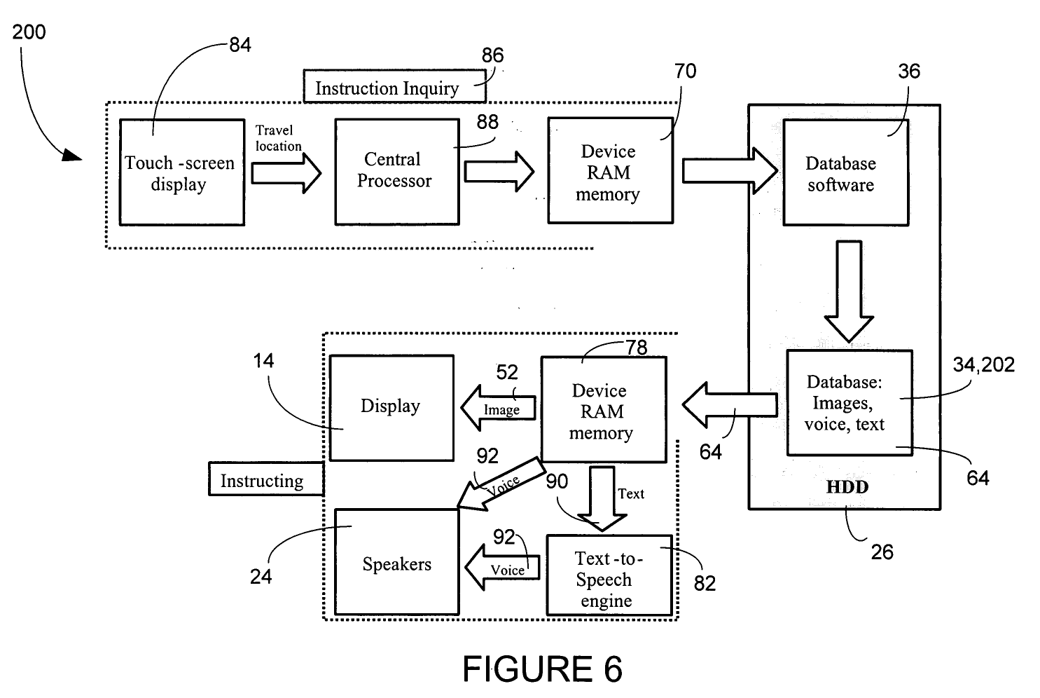

FIGS. 5-6 show the travel assistant 10 being used as a travel instructor device 200. When elements or functional blocks are similar to those previously described, the same element numbers will be used in the following description.

When used as a travel instructor device 200, a database 202 is accessed for specific information about the travel's present or intended location, or to give directions or commentary to the travel. The travel instructor device 200 can be activated by commands entered through a touch-screen 84 which presents various options to the user. One possible scenario involves the user's planned visit to a friend “Jack” who lives in Japan. Jack may have sent prerecorded instructions and directions to his house, which have been stored in a database #26 on the traveler's HDD 26. When the traveler arrives in the appropriate city in Japan, she may access database #26 by the touch-screen display 84, which sends a query 86 to the central processor 88, which is stored in device RAM memory 70 until the database software 36 retrieves the appropriate database 34, in this case database #26 202, which includes images, voice and text information included on digital image and voice files 64. These files 64 are sent to device RAM memory 78 where image 52 and voice 92 data are sent to the display screen 14 and speakers 24 respectively, or certain text files 90 may be sent to the text-to-speech engine 82 for processing into voice files 92 which are then sent to the speakers 24.

Thus, Jack's directions could include an image of a local landmark 204, with his pre-recorded comment 206 “Turn right at this red shrine and go towards the book store . . . ” The travel assistant's recording function through the microphone 22 and digital camera 20 also allows the traveler to add extra comments 208, perhaps for future reference, such as “This shrine isn't red!” These comments and images can be added to the database #26 202 and stored on the HDD 26.

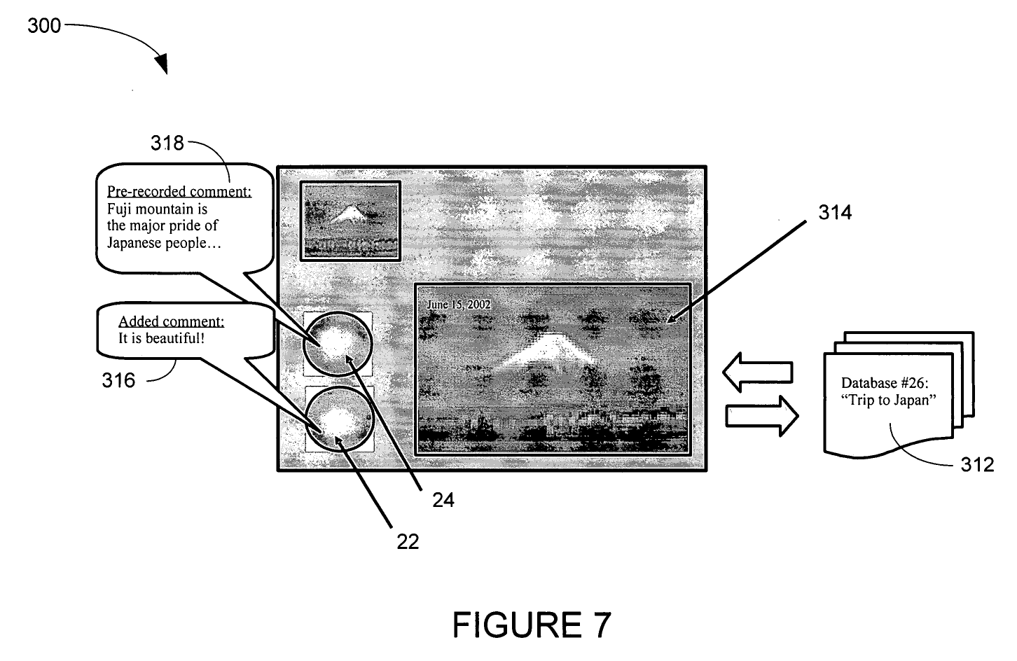

FIGS. 7-9 show the travel assistant 10 being used as a travel log or personal log device 300. When elements or functional blocks are similar to those previously described, the same element numbers will be used in the following description.

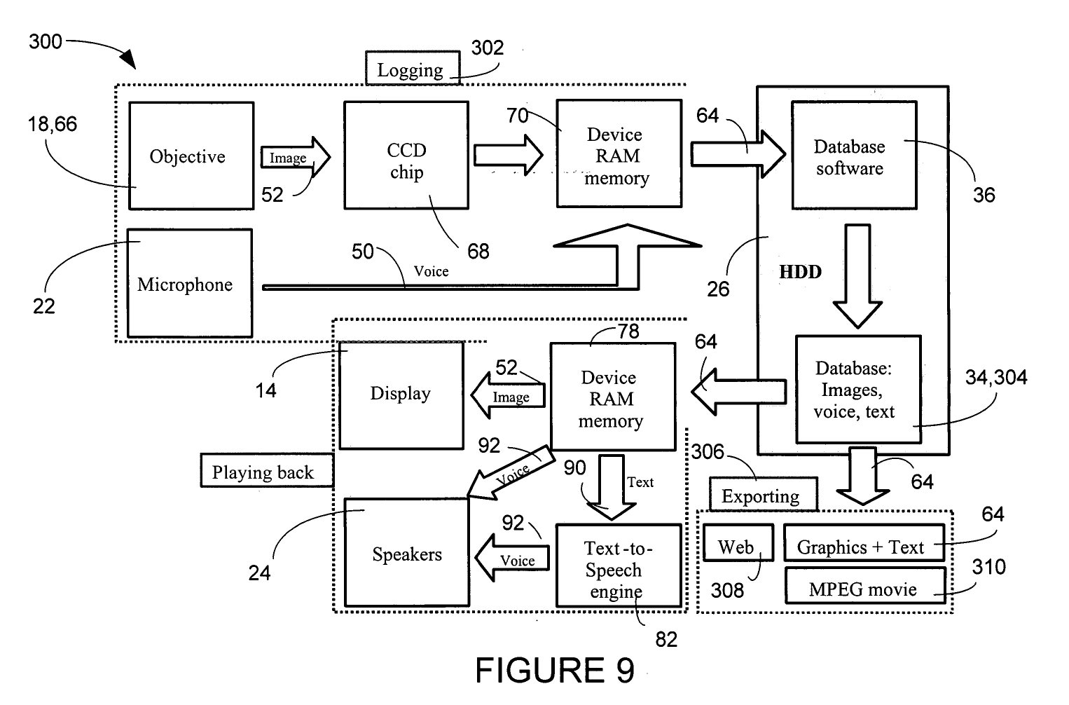

Referring now primarily to FIG. 9, when used as a personal log device 300, the digital camera 18 and microphone 22 are used for logging 302 information to the HDD 26. Images 52 enter the objective lens 66 of the digital camera 18, and activates a Charge Coupled Device (CCD chip) 68 before the image data is stored in a device RAM memory 70. This sequence of events can be referred to collectively as logging information 302.

As before, it is possible that a touch screen button (not shown) has previously be activated to initiate this series of events and to identify that the image is to be used for logging purposes.

The digital image and voice files 64 are sent to the HDD 26, where database software 36 routes the data to the database 34, which is specifically a logging database 304. The data is stored there until retrieved and the digital image and voice files 64 are called to be played back. If so, these files 64 are sent to device RAM memory 78 where image 52 and voice 92 data are sent to the display screen 14 and speakers 24 respectively, or certain text files 90 may be sent to the text-to-speech engine 82 for processing into voice files 92 which are then sent to the speakers 24.

Alternately, the digital image and voice files 64 can be exported 306 either to another external device, or to the web 308 in the form of digital image and voice files 64, or MPEG movies 310.

FIG. 7 shows one example, where elements of a prerecorded database #26 312 are recalled, and new images 314 and commentary 316 are added by the traveler to the prerecorded commentary 318 provided by the database 312.

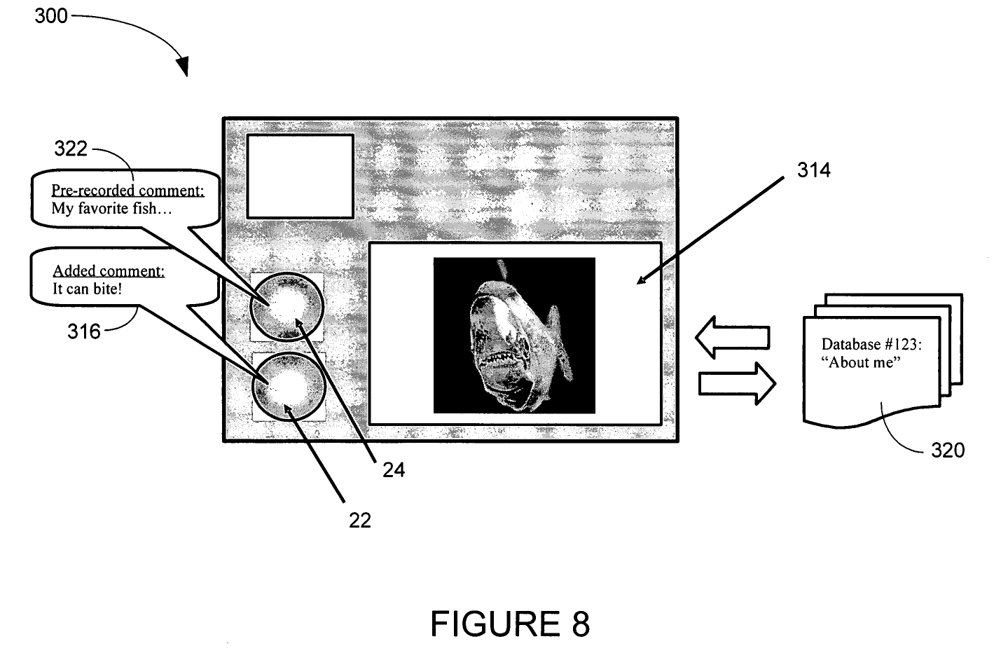

FIG. 8 shows another example where a personal database #123 320 has previously been established and stocked with images 314 and sound files recorded by the traveler. Previously recorded comments 322 can be recalled and then new commentary 316 added, as the original material is reviewed.

While the present invention has been shown and described with regard to certain preferred embodiments, it is to be understood that modifications in form and detail will no doubt be developed by those skilled in the art upon reviewing this disclosure. It is therefore intended that the following claims cover all such alterations and modifications that nevertheless include the true spirit and scope of the inventive features of the present invention.

1. A travel assistant device comprising:
a hard disk drive including at least one database;
a digital camera;
a microphone;
a display screen;
at least one speaker;
database software by which images and sound input from said digital camera and said microphone are stored in said hard disk drive as a personal log database, which can be displayed on said display screen and through said speaker, where said personal log database may be updated by the additional commentary and images as desired, and where said database software retrieves downloaded database information which includes images, sound files and text which act as a travel instructor; and
a portable translator device.

2. The travel assistant device of claim 1, further comprising:
a touch-screen display.

3. The travel assistant device of claim 1, wherein:
said display screen displays slides.

4. The travel assistant device of claim 1, wherein:
said display screen displays MPEG movies.

5. The travel assistant device of claim 1, wherein:
said at least one speaker plays sound files.

6. The travel assistant device of claim 1, further comprising:
a Global Positioning System (GPS) module.

7. The travel assistant device of claim 6, wherein:
said GPS allows downloads of interactive digital guide information.

8. The travel assistant device of claim 6, wherein:
said GPS allows tracking of the user.

9. The travel assistant device of claim 1, wherein:
said personal log database produces HTML files for output to web sites.

10. The travel assistant device of claim 1, wherein:
said personal log database produces MPEG movies.

11. The travel assistant device of claim 1, wherein said portable translator device comprisies:
an Optical Character Recognition engine, which takes input of graphic images of words from said digital camera in a language unfamiliar to the user and converts them to characters in said unfamiliar language; and
a dictionary module which takes said characters generated by said Optical Character Recognition engine and produces translated files in a language familiar to the user, and outputs said translated files to said view screen and said at least one speaker.

12. The travel assistant device of claim 11, further comprising:
a text-to-speech engine.

13. The travel assistant device of claim 1, further comprising:
an MP3 player.

14. A portable translator device comprising:
a hard disk drive including at least one database;
a digital camera which inputs graphic images of words in a language unfamiliar to the user;
an Optical Character Recognition engine which resides on said hard disk drive, which takes said input graphic images of words in a language unfamiliar to the user and converts them to characters in said unfamiliar language;
a dictionary module which is downloadable to said at least one database on said hard disk drive, and which takes said characters generated by said Optical Character Recognition engine and produces translated files in a language familiar to the user; and
at least one output device which takes said translated files and outputs them to the user.

15. The portable translator device of claim 14, wherein:
said at least one output device includes a display screen.

16. The portable translator device of claim 14, wherein:
said display screen displays slides.

17. The portable translator device of claim 14, wherein:
said display screen displays MPEG movies.

18. The portable translator device of claim 14, wherein:
said output device includes at least one speaker.

19. The portable translator device of claim 18, wherein:
said at least one speaker plays sound files.

20. The portable translator device of claim 19, wherein:
said output device includes a text-to-speech engine.

21. The portable translator device of claim 14, further comprising:
a personal log device.

22. The portable translator device of claim 14, further comprising:
a microphone.

23. The portable translator device of claim 22, further comprising:
database software by which images and sound input from said digital camera and said microphone are stored in said hard disk drive as a personal log database, which can be displayed on said display screen and through said speaker, where said personal log database may be updated by the additional commentary and images as desired.

24. The portable translator device of claim 23, wherein:
said personal log device produces HTML files for output to web sites.

25. The portable translator device of claim 23, wherein:
said personal log device produces MPEG movies.

26. The portable translator device of claim 14, further comprising:
a travel instructor device.

27. The portable translator device of claim 14, further comprising:
database software by which image and sound files from a downloadable database are stored in said hard disk drive as a travel instructor database, said images and sound files being displayable on said at least one output device and where said image and sound files act as a travel instructor.

28. The portable translator device of claim 14, further comprising:
a Global Positioning System (GPS) module.

29. The portable translator device of claim 28, wherein:
said GPS allows downloads of interactive digital guide information.

30. The portable translator device of claim 28, wherein:
said GPS allows tracking of the user.

31. The portable translator device of claim 1, further comprising:
an MP3 player.
